(19) United States
(12) Patent Application Publication
(10) Pub. No.: US 2026/0081329 A1
(43) Pub. Date: Mar. 19, 2026

(54) COOLANT SYSTEM CONNECTION COVER

(71) Applicant: GM GLOBAL TECHNOLOGY OPERATIONS LLC, Detroit, MI (US)

(72) Inventors: Simon James Hammond Trask, Royal Oak, MI (US); Jacob Reaume, Ferndale, MI (US)

(73) Assignee: GM GLOBAL TECHNOLOGY OPERATIONS LLC, Detroit, MI (US)

(21) Appl. No.: 18/887,665

(22) Filed: Sep. 17, 2024

(51) Int. Cl. H01M 50/636; H01M 10/613; H01M 10/625; H01M 10/6567

(52) U.S. Cl. CPC H01M 50/636; H01M 10/613; H01M 10/625; H01M 10/6567; H01M 2220/20

(57) ABSTRACT

A vehicle, a coolant system for a vehicle, and a method for assembling a coolant system are provided. A method includes providing a cooling plate formed with an external surface surrounding a port, and with an internal channel in communication with the port, wherein a plate engagement surface defines the internal channel adjacent to the port; sealing the port of the cooling plate with a cover; piercing the cover with a distal end of a coolant tube; inserting the distal end into the port to engage a tube engagement surface of the coolant tube with the plate engagement surface; and pushing a removed portion of the cover into the port, while a remaining portion of the cover remains around the port.

### INTRODUCTION

The disclosure relates to a fluid connection to a cooling plate with coolant flow for batteries and battery arrays.

A battery system or array may include a plurality of battery cells in relatively close proximity to one another. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Unless accompanied by effective cooling, such chemical reactions may cause more heat to be generated by the batteries than is effectively withdrawn, thereby causing battery damage. In battery arrays, liquid cooling is frequently employed to reduce the spread of thermal energy from a cell experiencing elevated temperature to adjacent cells.

Coolant systems may be used to cool secondary batteries. A coolant system may include a cooling plate that provides for direct heat transfer from a battery. The cooling plate may include an internal channel extending in a path from an inlet port to an outlet port. During assembly, the cooling plate may be positioned at a designated location in a vehicle for cooling a battery and then may be connected to a coolant tube and coolant reservoir. Before assembly, the ports of the cooling plate are typically covered with caps that must be removed before connection to the coolant tube. Otherwise, dust or other unwanted contaminants may enter the internal channel of the cooling plate.

Accordingly, there is a need for devices and methods for simplifying assembly of a coolant system for a battery. Furthermore, other desirable features and characteristics of the present disclosure will become apparent from the subsequent detailed description and the appended claims, taken in conjunction with the accompanying drawings and the foregoing technical field and background.

### SUMMARY

In one embodiment, a method for assembling a coolant system includes providing a cooling plate formed with an external surface surrounding a port, and with an internal channel in communication with the port, wherein a plate engagement surface defines the internal channel adjacent to the port; sealing the port of the cooling plate with a cover; piercing the cover with a distal end of a coolant tube; inserting the distal end into the port to engage a tube engagement surface of the coolant tube with the plate engagement surface; and pushing a removed portion of the cover into the port, while a remaining portion of the cover remains around the port.

In certain embodiments of the method, sealing the port of the cooling plate with the cover includes adhering the cover to the external surface surrounding the port.

In certain embodiments of the method, piercing the cover with the distal end of the coolant tube and inserting the distal end into the port to engage the tube engagement surface with the plate engagement surface includes tearing the cover.

In certain embodiments of the method, the cover is perforated with perforations, and the perforations separate the remaining portion from the removed portion.

In certain embodiments of the method, a sealing feature is located on the tube engagement surface of the coolant tube or on the plate engagement surface of the internal channel.

In certain embodiments, the method further includes flowing coolant through the coolant tube and the internal channel; and dissolving the removed portion of the cover in the coolant.

In certain embodiments of the method, the remaining portion of the cover remains on the external surface of the cooling plate after the removed portion is dissolved.

In certain embodiments, the method further includes after sealing the port of the cooling plate, transporting the cooling plate to an assembly location; and while transporting the cooling plate to the assembly location, preventing particulate from entering the internal channel with the cover; wherein piercing the cover with the distal end of the coolant tube and inserting the distal end into the port is performed after transporting the cooling plate to the assembly location.

In certain embodiments, the method further includes forming the cover by providing a sheet having first side and a second side; applying an adhesive to the first side of the sheet; and die-cutting the sheet to form a plurality of covers, each cover is dimensioned to fit on the external surface of the cooling plate; and sealing the port of the cooling plate with the cover includes adhering the adhesive to the external surface of the cooling plate.

In certain embodiments of the method, the cooling plate includes a substantially planar plate member including an opening; and a connector member including the external surface, the port, and the plate engagement surface inside the port, the connector member is formed with a channel segment extending from the port to a hole; and the method further includes aligning the hole of the connector member and the opening of the plate member; and fixing the connector member to the plate member.

In certain embodiments of the method, the connector member is further formed with a bore, the coolant tube includes a tab, and the method further includes fixing the coolant tube to the connector member by engaging a fastener with the tab and the bore of the connector member.

In certain embodiments of the method, the bore and the channel segment are parallel.

In another embodiment, a coolant system for a vehicle includes a cooling plate including a plate member and a connector member; wherein the plate member includes an opening in communication with an internal passageway; wherein the connector member includes a top surface surrounding a port, and a channel segment in communication with the port; wherein the connector member is fixed to the plate member such that the channel segment is in communication with the internal passageway; a coolant tube including a distal end and a radially-extending tab adjacent to the distal end, wherein the radially-extending tab has a bottom surface, and wherein the distal end is received within the channel segment of the connector member; and an annular cover located between the bottom surface and the top surface and surrounding the port.

In certain embodiments of the coolant system, the annular cover is water soluble.

In certain embodiments, the coolant system further includes a fastening extending through the radially-extending tab of the coolant tube and extending into the connector member of the cooling plate.

In certain embodiments, the coolant system further includes a sealing feature located between the distal end of the coolant tube and the channel segment of the connector member.

In another embodiment, a vehicle includes a battery; a battery coolant system including a cooling plate including a plate member and a connector member; wherein the plate member includes an opening in communication with an internal passageway; wherein the connector member includes a top surface surrounding a port, and a channel segment in communication with the port; wherein the connector member is fixed to the plate member such that the channel segment is in communication with the internal passageway; a coolant tube including a distal end and a radially-extending tab adjacent to the distal end, wherein the radially-extending tab has a bottom surface, and wherein the distal end is received within the channel segment of the connector member; and an annular cover located between the bottom surface and the top surface and surrounding the port.

In certain embodiments of the vehicle, the annular cover is water soluble.

In certain embodiments of the vehicle, the battery coolant system further includes a fastening extending through the radially-extending tab of the coolant tube and extending into the connector member of the cooling plate.

In certain embodiments of the vehicle, the battery coolant system further includes a sealing feature located between the distal end of the coolant tube and the channel segment of the connector member.

### DESCRIPTION OF THE DRAWINGS

The present disclosure will hereinafter be described in conjunction with the following drawing figures, wherein like numerals denote like elements, and wherein:

FIG. 1 is a schematic top view of an embodiment of a vehicle with a powertrain and a battery module using a battery array configured to generate and store electrical energy, according to various embodiments.

FIG. 2 is a schematic top perspective exploded view of the battery module shown in FIG. 1, having a cooling plate configured to distribute a flow of coolant for managing heat transfer from the battery array to the environment, according to various embodiments.

FIG. 3 is a schematic close-up top view of one embodiment of the cooling plate shown in FIG. 2, according to various embodiments.

FIG. 4 is a perspective view of a coolant assembly for interconnecting the cooling plate of FIG. 3 to a coolant supply, according to various embodiments.

FIG. 5 is an overhead view of the connector member of the coolant assembly of FIG. 4, according to various embodiments.

FIG. 6 is an overhead view of the cover of the coolant assembly of FIG. 4, according to various embodiments.

FIG. 7 is a cross-sectional view of the cover adhered to the connector member, taken along line 7-7 in FIGS. 5 and 6, according to various embodiments.

FIG. 8 is a cross-sectional view of the coolant assembly of FIG. 4, taken along the same cross-section as FIG. 7, according to various embodiments.

FIG. 9 is a cross-sectional view of the coolant assembly of FIG. 8, at a next stage of assembly, according to various embodiments.

FIG. 10 is a cross-sectional view of the coolant assembly of FIG. 9, at a next stage of assembly, according to various embodiments.

FIG. 11 is a schematic illustrating a method for assembling a coolant system, according to various embodiments.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description.

Embodiments of the present disclosure may be described herein in terms of functional and/or logical block components and various processing steps. Connecting lines shown in the various figures contained herein are intended to represent example functional relationships and/or physical couplings between the various elements. It should be noted that many alternative or additional functional relationships or physical connections may be present in an embodiment of the present disclosure.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

Embodiments herein provide for preventing contamination of the inner channel of a cooling plate between the time of manufacture and the time of connection to a coolant reservoir for cooling a battery in a vehicle. Specifically, embodiments herein provide for covering the port or ports of the cooling plate with a cover or covers. At the time of connection to the coolant reservoir, the cover is not removed. Rather, the cover is punctured by a coolant tube and the cooling plate is interconnected in fluid communication with the cooling tube without removing the cover.

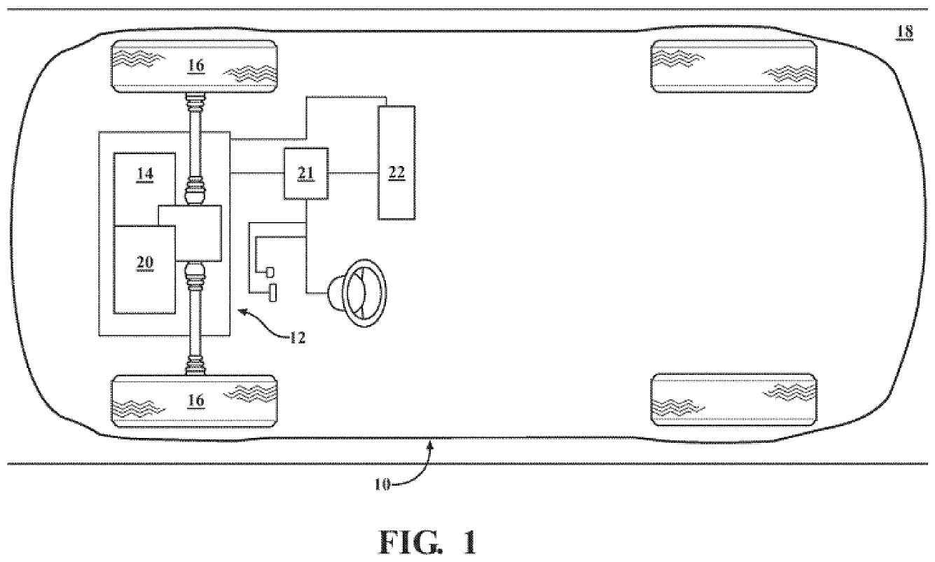

Referring to the drawings, wherein like reference numbers correspond to like or similar components wherever possible throughout the several figures, an electric vehicle 10 is shown in FIG. 1.

Cross-referencing FIGS. 1-3, the vehicle 10 has a powertrain 12. FIG. 1 illustrates the electric vehicle 10 as an automobile, such as any one of a number of different types of automobiles, such as, for example, a sedan, a wagon, a truck, sport utility vehicle (SUV), or the like. In certain implementations, the vehicle 10 may comprise a motorcycle or other land-based vehicle, such as a rail locomotive, or a non-land-based vehicle such as aircraft, spacecraft, watercraft, and so on, and/or one or more other types of mobile platforms (e.g., a robot and/or another mobile platform). In yet other implementations, the battery module described below may instead be part of and/or coupled to any number of other types of platforms and/or other systems, moving or non-moving, such as a building, infrastructure, secondary use, home power, non-automotive, and/or other platforms and/or other systems.

The powertrain 12 includes a power-source 14 configured to generate a power-source torque for propulsion of the vehicle 10 via driven wheels 16 relative to a road surface 18. The power-source 14 is depicted as an electric motor-generator. The powertrain 12 may also include an additional power-source 20, such as an internal combustion engine. The power-sources 14 and 20 may act in concert to power the vehicle 10. The vehicle 10 additionally includes a programmable electronic controller 21 and a battery module 22. The battery module 22 may include one or more battery sections 24, such as cells or arrays, configured to generate and store electrical energy for powering the power-sources 14 and 20. Each battery section 24 in the battery module 22 generates and stores electrical energy through heat-producing electro-chemical reactions. Operation of the powertrain 12 and the battery module 22 may generally be regulated by the electronic controller 21.

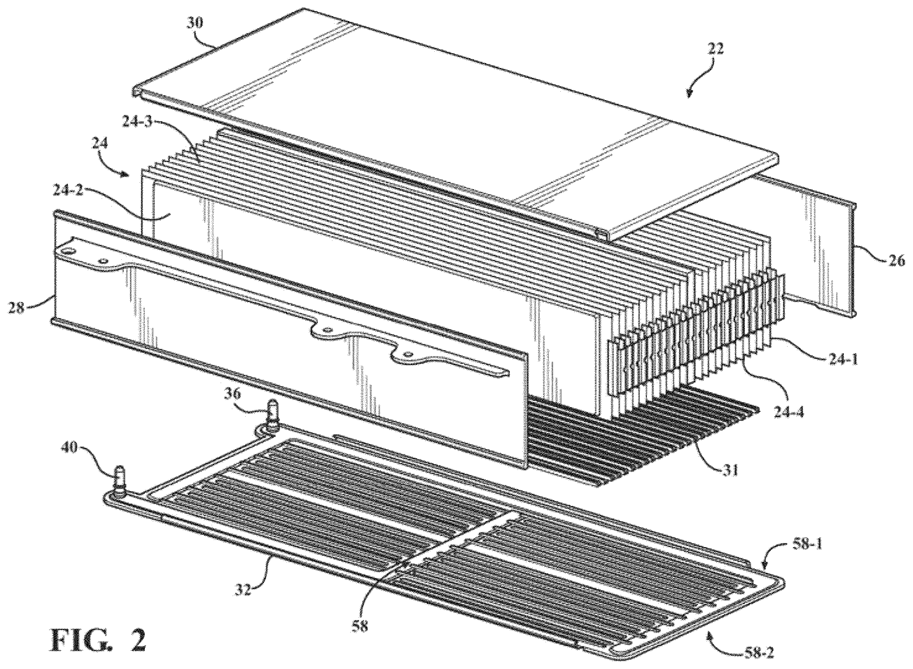

As shown in FIG. 2, the battery section 24 has a first side-wall 24-1, a second side-wall 24-2, a top surface 24-3, and a bottom surface 24-4. The battery module 22 includes a first side plate 26, a second side plate 28, and a cover 30 attached to the first and second side plates. The first side plate 26, the second side plate 28, and the cover 30 are configured to bound the battery section 24 on the respective first side-wall 24-1, second side-wall 24-2, and top surface 24-3. As additionally shown in FIG. 2, an epoxy layer 31 may be applied to the bottom surface 24-4 of the battery section 24. The battery module 22 also includes a cooling plate 32 configured to manage heat transfer from the battery section 24 to the environment. The cooling plate 32 is attached to the first and second side plates 26, 28 to thereby bound the battery section 24 on the bottom surface 24-4. The cooling plate 32 may be additionally affixed to the bottom surface 24-4 of the battery section 24 via the epoxy layer 31.

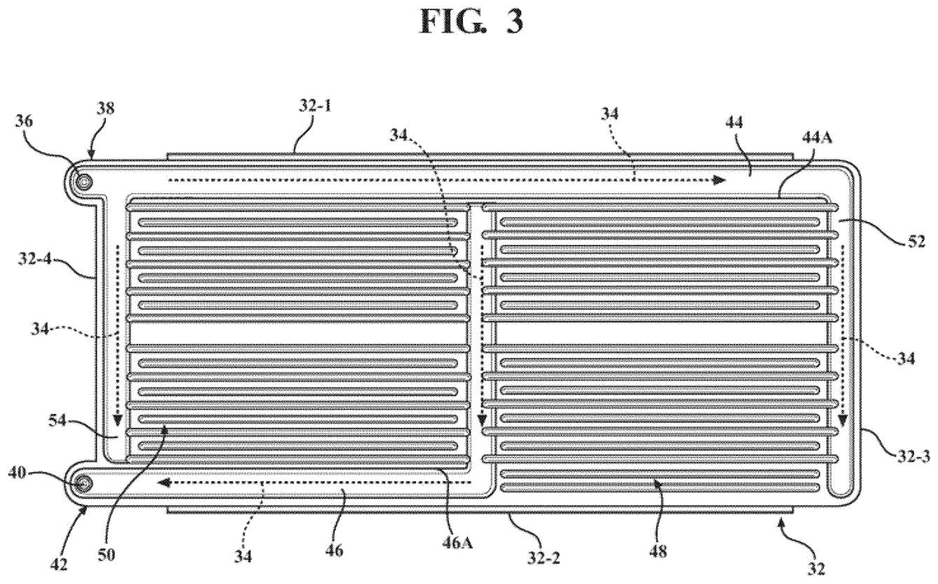

As shown in FIG. 3, the cooling plate 32 is defined by a first perimeter edge 32-1 and second perimeter edge 32-2, wherein the first perimeter edge is parallel to the second perimeter edge. The cooling plate 32 is additionally defined by a third perimeter edge 32-3 and fourth perimeter edge 32-4, wherein the third perimeter edge is parallel to the fourth perimeter edge. The first and second perimeter edges 32-1, 32-2 are also orthogonal to the third and fourth perimeter edges 32-3, 32-4. The cooling plate 32 is further defined by a plate surface area A.

The cooling plate 32 is configured to accept a flow of circulating coolant 34 therethrough to remove heat produced by the battery section 24. To that end, as shown in FIG. 3, the cooling plate 32 includes a coolant inlet 36 arranged at a junction 38 between the first perimeter edge 32-1 and the fourth perimeter edge 32-4. The cooling plate 32 also includes a coolant outlet 40 arranged at a junction 42 between the second perimeter edge 32-2 and the fourth perimeter edge 32-4. A first coolant channel 44 is arranged along the first perimeter edge 32-1 and in direct fluid communication with the coolant inlet 36. A second coolant channel 46 is arranged along the second perimeter edge 32-2 and in direct fluid communication with the coolant outlet 40. Additionally, the cooling plate 32 includes a first set of coolant mini-channels 48 and a second set of coolant mini-channels 50. Each of the first and second set of coolant mini-channels 48, 50 is arranged parallel to and along the first and second perimeter edges 32-1, 32-2, and, therefore, transverse the third and fourth perimeter edges 32-3, 32-4. Each of the first and second set of coolant mini-channels 48, 50 is in direct fluid communication with the second coolant channel 46. The first and second set of coolant mini-channels 48, 50 are together configured to distribute the flow of circulating coolant 34 across the plate surface area A.

The cooling plate 32 also includes a first coolant manifold 52 arranged proximate the third perimeter edge 32-3 and a second coolant manifold 54 arranged proximate the fourth perimeter edge 32-4. The first coolant manifold 52 is in direct fluid communication with the first coolant channel 44. The second coolant manifold 54 is in direct fluid communication with the coolant inlet 36. Additionally, the first and second coolant manifolds 52, 54 are in fluid communication with the coolant outlet 40 via the first set and the second set of coolant mini-channels 48, 50, respectively. In other words, the first and second coolant manifolds 52, 54 are configured to receive at least a portion of the circulating coolant 34 flow and distribute the subject portion of the coolant flow across the respective coolant mini-channels 48, 50. In turn, as the flow of circulating coolant 34 passes through the coolant mini-channels 48, 50, the mini-channels are configured to direct the respective distributed portions of the coolant 34 flow to the coolant outlet 40.

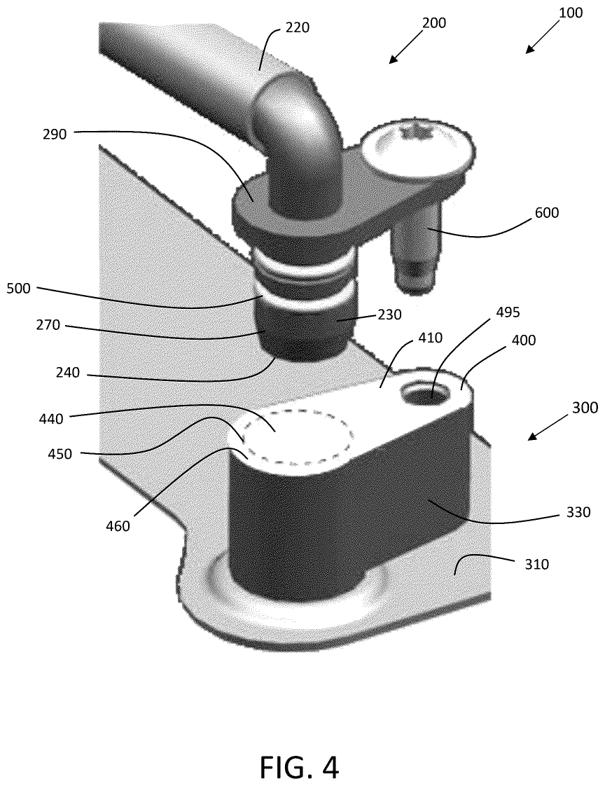

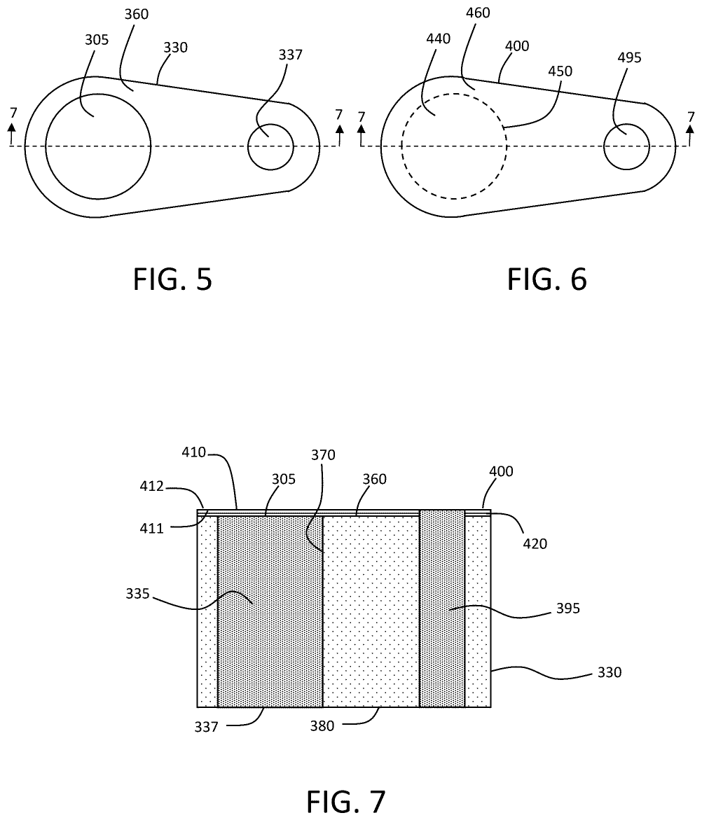

With continued reference to FIG. 3, each the first and second coolant channels 44, 46 may be defined by respective channel boundaries 44A, 46A and respective coolant channel surfaces 44B, 46B. As shown, in FIG. 5, the coolant channel boundaries 44A, 46A may be defined by a sinusoidal shape. The sinusoidal shape of the particular coolant channel boundary 44A or 46A is intended to generate turbulence in the flow of coolant 34 through the subject coolant channel 44 or 46 and thereby promote transfer of heat from the coolant 34 in the subject coolant channel to the environment. As shown in FIGS. 4 and 5, at least one of the first and second coolant channels 44, 46 may include feature(s) 56 arranged on the channel surface 44B or 46B. The feature(s) 56 are intended to create micro-channels 44C, 46C within the respective coolant channel 44 or 46, and configured to induce turbulence and vortices in the flow of coolant 34 passing therethrough, to thereby aid transfer of heat to the environment. The feature(s) 56 may be a plurality of protrusions or convexities extending into the flow of circulating coolant 34. Such protrusions may be defined by deformations of the coolant channel surface 44B or 46B.

As shown in FIG. 3, each of the first set and the second set of coolant mini-channels 48, 50 may be defined by respective mini-channel boundaries 48A, 50A configured to separate the coolant mini-channels from one another. As shown, in FIGS. 4-5, and similar to the coolant channel boundaries 44A, 46A in the first or second coolant channels 44, 46, one or more of the mini-channel boundaries 48A, 50A may be defined by a sinusoidal shape. The sinusoidal shape of the particular mini-channel boundaries 48A, 50A is intended to generate turbulence in the flow of coolant 34 through the subject mini-channel 48 or 50 and thereby promote transfer of heat from the coolant 34 in the subject mini-channel to the environment. Each of the mini-channels 48, 50 may be defined by a respective mini-channel surface 48B, 50B. Additionally, one or more of the mini-channels may include feature(s) 56 arranged on the mini-channel surface 48B or 50B. Analogously to the feature(s) 56 in the first or second coolant channels 44, 46, the feature(s) 56 in the mini-channels 48, 50 are intended to create micro-channels 48C, 50C within the respective mini-channels, and configured to induce turbulence and vortices in the flow of coolant 34 passing therethrough. As with the first and second coolant channels 44, 46, the feature(s) 56 may be a plurality of protrusions extending into the flow of circulating coolant 34. Such protrusions may be defined by deformations of the mini-channel surface 48B or 50B.

As shown in FIG. 2, the cooling plate 32 may have a clamshell construction 58. The clamshell construction 58 may include two sub-plates 58-1, 58-2 fused together and configured to define the respective coolant channel surfaces 44B, 46B and the respective mini-channel surfaces 48B, 50B.

FIG. 4 provides a perspective view of a portion of a cooling plate 300, such as cooling plate 32. As shown, cooling plate 300 includes a plate member 310 and a connector member 330. Connector member 330 may be fixed to plate member 310. For example, connector member 330 may be brazed to plate member 310, adhered to plate member 310, or fixed to plate member 310 in another suitable manner.

FIG. 4 further shows a coolant tube 200 positioned over and aligned with the cooling plate 300 in preparation of interconnection therebetween. A cover 400 is located over the cooling plate 300 to prevent dust, particulate, or other foreign matter from entering the cooling plate 300 before interconnection. A sealing feature 500, such as an O-ring, may be provided for sealing the interconnection. Further, a fastener or engagement feature 600, such as a bolt, may be provided for engaging the coolant tube 200 and cooling plate 300.

Collectively, the coolant tube 200, cooling plate 300, cover 400, sealing feature 500, and engagement feature 600 form a coolant system 100, or an assembly for a coolant system 100.

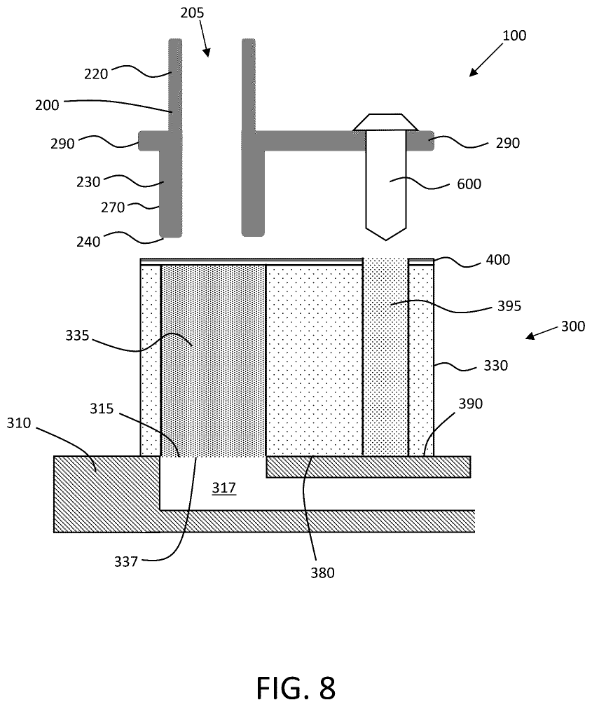

FIGS. 5, 6, 7, and 8 further illustrate features of the coolant system 100 of FIG. 4. For example, FIG. 5 is an overhead view of the connector member 330; FIG. 6 is an overhead view of the cover 400; FIG. 7 is a cross-sectional view of the cover 400 adhered to the connector member 330, taken along line 7-7 in FIGS. 5 and 6; and FIG. 8 is a similar cross-sectional view of the coolant assembly 100 of FIG. 4.

FIG. 5 illustrates that connector member 330 has an upper external surface 360. The upper external surface 360 is formed with a port 305. Specifically, the upper external surface 360 is formed with an annular shape and surrounds port 305. The upper external surface 360 is formed with a port 305. The upper external surface 360 is further formed with an opening 393.

Cross-referencing FIGS. 5 and 7, connector member 330 is formed with an internal channel segment 335 that extends from the port 305 in the upper surface 360 to a hole 337 in an opposite bottom surface 380. Connector member 330 includes an internal plate engagement surface 370 that at least partially defines the internal channel segment 335. Also, connector member 330 is formed with a bore 395 that extends from the opening 393 in the upper surface 360 into the connector member 330. In certain embodiments, bore 395 extends to the opposite bottom surface 380. In other embodiments, bore 395 may be blind i.e., end within the connector member 330. As shown, the internal channel segment 335 and the bore 395 may be parallel.

FIG. 6 illustrates that cover 400 is formed with a same shape and size, i.e., footprint, as the upper surface 360 of connector member 330. As shown, cover 400 is formed with an opening 495. Also, cover 400 includes perforations 450 that surround cover portion 440, and separate cover portion 440 from a surrounding portion 460 of cover 400. Perforations 450 are configured to facilitate ripping or tearing the cover 400 along the path defined by the perforations 450 to separate portion 440 from portion 460.

Cross-referencing FIGS. 6 and 7, cover 400 is formed from a sheet 410. For example, sheet 410 may be a water-soluble film. As shown, sheet 410 includes a bottom surface 411 and an opposite top surface 412. Further, cover 400 may include an adhesive layer 420 located on the bottom surface 411. In certain embodiments, the adhesive layer 420 is formed from a water soluble adhesive.

In FIG. 7, adhesive layer 420 is adhered to upper external surface 360 of the connector member 330. As shown, the opening 495 in cover 400 is aligned with the opening 393 and bore 395 of connector member 330. Further, the perforations 450 are aligned with the port 305 of connector member 330 such that cover portion 460 is adhered to upper external surface 360 while cover portion 440 covers port 305.

FIG. 8 further illustrates the interconnection of the connector member 330 and plate member 310 of cooling plate 300. As shown, plate member 310 includes an upper surface 390 that is formed with an opening 315 in communication with an internal channel 317. While not illustrated in FIG. 8, the internal channel 317 may include coolant mini-channels configured to distribute the flow of circulating coolant across a plate surface.

As shown in FIG. 8, the connector member 330 is fixed to the plate member 310. Specifically, the bottom surface 380 of connector member 330 is fixed to the upper surface 390 of plate member 310. As shown, the opening 315 in the plate member 310 is aligned with the hole 337 in bottom surface 380 such that the internal channel 317 is in fluid communication with the internal channel segment 335.

Cross-referencing FIGS. 4 and 8, the coolant tube 200 includes a proximal portion 220 and a distal portion 230 formed with an inner channel 205. At the proximal portion 220, the inner channel 205 may be in fluid communication with a coolant reservoir or tank (not shown). As shown, the coolant tube 200 includes a radially-extending tab 290. The distal portion 230 extends downward from the tab 290 to a distal end 240. As shown, the distal portion 230 includes an outer tube engagement surface 270. As further shown, the tab 290 may be formed with an opening 295. Further, an fastener 600 may be passed through the opening 295.

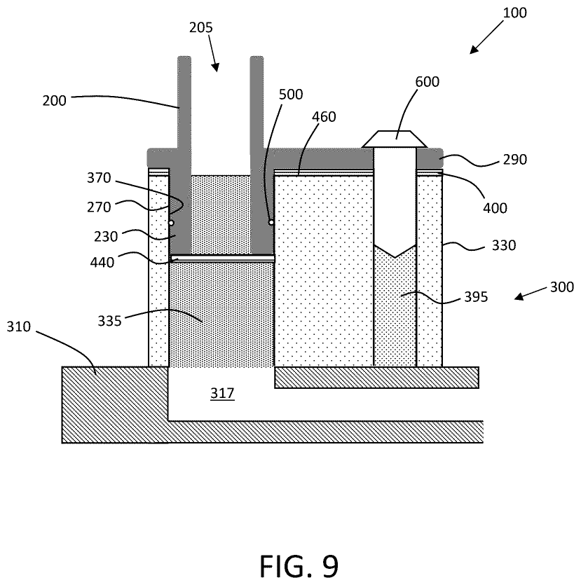

FIG. 9 illustrates a next stage of assembly of the coolant system 100. Specifically, the distal portion 230 of the cooling tube 200 is inserted into the channel segment 335 of the connector member 330. As shown, cooling tube 200 may be moved downward into contact with the connector member 330 such that the tab 290 contacts the cover 400. Further, the fastener 600 may be received in, and engaged by, the bore 395.

During insertion of the distal portion 230, the distal portion 230 pushes the cover portion 440 into the channel segment 335. Specifically, the force of the distal portion 230 of the cooling tube 200 rips the cover 400 along the perforations 450, disengaging the cover portion 440 from the remaining portion 460. While FIG. 9 illustrates that the cover portion 440 is completely separated from the remaining portion 460, it is contemplated that such separation may be incomplete such that the cover portion 440 is connected to the remaining portion 460 an at edge.

After engaging the coolant tube 200 with the connector member 330, the inner channel 205, inner channel segment 335, and internal channel 317 are in sealed fluid communication with another. For example, the sealing feature 500 may seal the connection between the coolant tube 200 and the connector member 330.

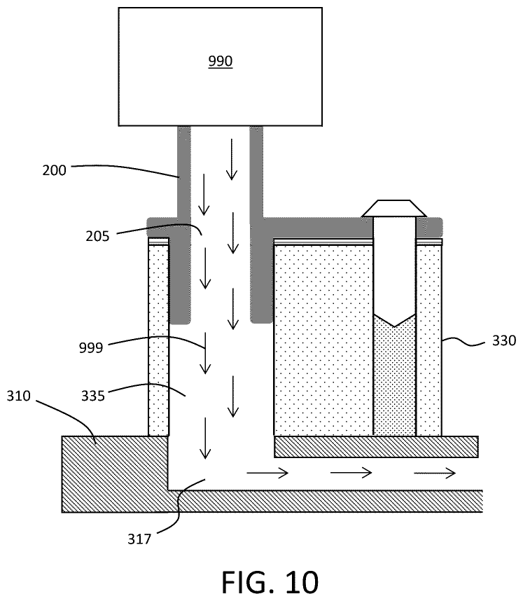

FIG. 10 illustrates a next stage of assembly of the coolant system 100. Specifically, a coolant fluid 999 flows from a reservoir 990, through the inner channel 205, inner channel segment 335, and internal channel 317. The cover portion 440 is soluble in the coolant fluid 999. Therefore, the cover portion 440 dissolves in the coolant fluid 999 as shown.

Thus, the coolant system 100 provides for covering the inner channel segment 335 and internal channel 317 with cover 400 before connection with the coolant tube 200. Further, the coolant system 100 does not require that the cover 400 be removed before connection with the coolant tube 200. Rather, the connection process forms an opening in the cover, defined by, or defined at least partially by, the perforations; and the coolant fluid 999 dissolves the removed cover portion 440 when the coolant fluid is introduced to the cooling plate 300.

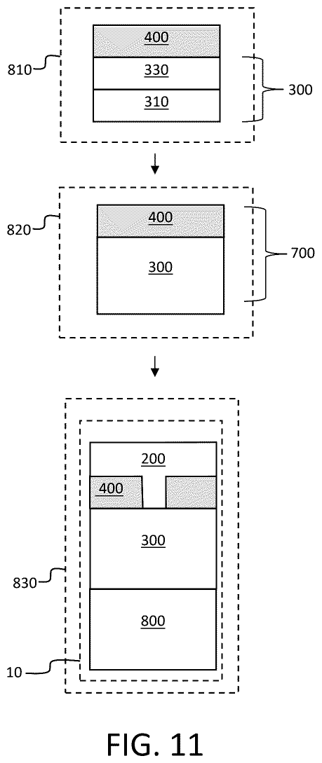

FIG. 11 schematically illustrates a process for assembling the coolant system 100. The process may include manufacturing a plurality of plate members 310 and connector members 330. Further, the process may include manufacturing of plurality of covers 400, wherein each cover 400 is formed to fit to the external surface of a connector member 330. The process may include providing a sheet or sheets, each having first side and a second side, applying an adhesive to the first side of each sheet; and die-cutting each sheet to form a plurality of covers.

As shown, process includes fixing together a plate member 310 and a connector member 330 at a manufacturing location 810 to form the cooling plate 300. For example, the process may include aligning the hole of the connector member and the opening of the plate member, and fixing the connector member to the plate member.

Further, the process includes adhering a cover 400 to the cooling plate 300 to cover the port as described above. It is noted that the cooling plate 300 may have more than one port. The process may include covering each port of the cooling plate 300 with a cover 400 at the manufacturing location 810.

After sealing the port(s) with the cover(s), the process may include transferring the sealed product form of the cooling plate 300 to a storage and/or shipping location 820. For example, the process may include storing a manufactured lot 700 of cooling plates 300 in a storage unit or shipping container 820. In certain embodiments, the process may include shipping the manufactured lot 700 to a vehicle assembly location 830. In certain embodiments, the process may include storing the manufactured lot 700 at a vehicle assembly location 830. While storing or transporting the sealed product form of the cooling plate 300, the process further includes preventing particulate from entering the internal channel with the cover.

The process further includes assembling a vehicle 10. When assembly of a vehicle 10 occurs, the process includes positioning the sealed product form of a cooling plate 300 in the vehicle 10, such as adjacent to a battery 800. Further, assembling includes interconnecting the cooling tube 200 with the cooling plate 300 through the cover 400 as described above. For example, the process may include fixing the coolant tube to the connector member by engaging a fastener with the tab and the bore of the connector member.

After assembly, the process may include flowing coolant through the coolant tube and the internal channel and dissolving the removed portion of the cover in the coolant.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for assembling a coolant system comprising:
providing a cooling plate formed with an external surface surrounding a port, and with an internal channel in communication with the port, wherein a plate engagement surface defines the internal channel adjacent to the port;
sealing the port of the cooling plate with a cover;
piercing the cover with a distal end of a coolant tube;
inserting the distal end into the port to engage a tube engagement surface of the coolant tube with the plate engagement surface; and
pushing a removed portion of the cover into the port, while a remaining portion of the cover remains around the port.

2. The method of claim 1, wherein sealing the port of the cooling plate with the cover comprises adhering the cover to the external surface surrounding the port.

3. The method of claim 2, wherein piercing the cover with the distal end of the coolant tube and inserting the distal end into the port to engage the tube engagement surface with the plate engagement surface comprises tearing the cover.

4. The method of claim 2, wherein the cover is perforated with perforations, and wherein the perforations separate the remaining portion from the removed portion.

5. The method of claim 1, wherein a sealing feature is located on the tube engagement surface of the coolant tube or on the plate engagement surface of the internal channel.

6. The method of claim 1, further comprising:
flowing coolant through the coolant tube and the internal channel; and
dissolving the removed portion of the cover in the coolant.

7. The method of claim 6, wherein the remaining portion of the cover remains on the external surface of the cooling plate after the removed portion is dissolved.

8. The method of claim 1, further comprising:
after sealing the port of the cooling plate, transporting the cooling plate to an assembly location; and
while transporting the cooling plate to the assembly location, preventing particulate from entering the internal channel with the cover;
wherein piercing the cover with the distal end of the coolant tube and inserting the distal end into the port is performed after transporting the cooling plate to the assembly location.

9. The method of claim 1, further comprising forming the cover by:
providing a sheet having first side and a second side,
applying an adhesive to the first side of the sheet; and
die-cutting the sheet to form a plurality of covers, wherein each cover is dimensioned to fit on the external surface of the cooling plate; and wherein sealing the port of the cooling plate with the cover comprises adhering the adhesive to the external surface of the cooling plate.

10. The method of claim 1, wherein the cooling plate comprises a substantially planar plate member including an opening; and a connector member including the external surface, the port, and the plate engagement surface inside the port, wherein the connector member is formed with a channel segment extending from the port to a hole; and wherein the method further comprises:
aligning the hole of the connector member and the opening of the plate member; and
fixing the connector member to the plate member.

11. The method of claim 10, wherein the connector member is further formed with a bore, wherein the coolant tube includes a tab, and wherein the method further comprises fixing the coolant tube to the connector member by engaging a fastener with the tab and the bore of the connector member.

12. The method of claim 11, wherein the bore and the channel segment are parallel.

13. A coolant system for a vehicle comprising:
a cooling plate including a plate member and a connector member; wherein the plate member includes an opening in communication with an internal passageway; wherein the connector member includes a top surface surrounding a port, and a channel segment in communication with the port; wherein the connector member is fixed to the plate member such that the channel segment is in communication with the internal passageway;
a coolant tube comprising a distal end and a radially-extending tab adjacent to the distal end, wherein the radially-extending tab has a bottom surface, and wherein the distal end is received within the channel segment of the connector member; and
an annular cover located between the bottom surface and the top surface and surrounding the port.

14. The coolant system of claim 13, wherein the annular cover is water soluble.

15. The coolant system of claim 14, further comprising a fastening extending through the radially-extending tab of the coolant tube and extending into the connector member of the cooling plate.

16. The coolant system of claim 15, further comprising a sealing feature located between the distal end of the coolant tube and the channel segment of the connector member.

17. A vehicle comprising:
a battery; and
a battery coolant system comprising:
a cooling plate including a plate member and a connector member; wherein the plate member includes an opening in communication with an internal passageway; wherein the connector member includes a top surface surrounding a port, and a channel segment in communication with the port; wherein the connector member is fixed to the plate member such that the channel segment is in communication with the internal passageway;
a coolant tube comprising a distal end and a radially-extending tab adjacent to the distal end, wherein the radially-extending tab has a bottom surface, and wherein the distal end is received within the channel segment of the connector member; and
an annular cover located between the bottom surface and the top surface and surrounding the port.

18. The vehicle of claim 17, wherein the annular cover is water soluble.

19. The vehicle of claim 18, wherein the battery coolant system further comprises a fastening extending through the radially-extending tab of the coolant tube and extending into the connector member of the cooling plate.

20. The vehicle of claim 19, wherein the battery coolant system further comprises a sealing feature located between the distal end of the coolant tube and the channel segment of the connector member.
